(19) United States
(12) Patent Application Publication
(10) Pub. No.: US 2015/0227940 A1
(43) Pub. Date: Aug. 13, 2015

(54) System and Method of Routing a Search Query to a Forum

(71) Applicant: CrowdCare Corporation, Richmond Hill (CA)

(72) Inventors: Jeffrey Brunet, Aurora (CA); Yousuf Chowdhary, Maple (CA); Ian Collins, Markham (CA)

(21) Appl. No.: 14/619,275

(22) Filed: Feb. 11, 2015

Related U.S. Application Data
(60) Provisional application No. 61/965,963, filed on Feb. 12, 2014.

(51) Int. Cl. G06Q 30/00; G06F 17/30

(52) U.S. Cl. CPC G06Q 30/016; G06F 17/30976

(57) ABSTRACT

A method is provided for providing customer care to a user of an electronic device. An information query package is created from text added by the user in a query about the electronic device, as well as, a device profile of the electronic device. The customer care case is automatically routed to an appropriate forum based on an analysis of the information query package. The forum selection may include screening for compatibility of the customer care case with a particular forum based on factors such as language, expertise and availability.

### CROSS-REFERENCE TO RELATED APPLICATIONS

This application claims the benefit of U.S. Provisional Patent Application No. 61/965,963, filed Feb. 12, 2014 and entitled “System and Method of Routing a Search Query to a Forum,” which is incorporated herein by reference in its entirety.

### FIELD OF INVENTION

The invention in general relates to customer care systems for electronic devices and in particular relates to electronic communication devices for example Smartphones, tablets, TVs, entertainment systems, vehicles, navigation systems etc.

### BACKGROUND

When users face a problem with their devices they have a few different ways to try and solve the issue. They may call the device manufacturer's support line or may contact the service provider and/or in parallel they may also search for an answer over the internet from other sources of help. This last method is gaining strength and falls in the category of self-care, a model preferred by manufacturers and service providers as it lowers their overhead costs and forces a user to spend their own time and effort with some help (e.g. FAQs posted on a website, or a help forum) to solve the issue.

In self-care some base information is provided to the users and they can use the information to resolve some of the issues themselves. While some central knowledge-bases offer limited help for example static lists of “frequently asked questions” they become outdated quickly as the state of the devices continues to change rapidly. Such methods still lack automation and the user is required to sift through massive amounts of data manually to get to the relevant information.

In the course of a customer care session when a user is trying to get help regarding an issue on their device, a CSR (Customer Service Representative) must undertake the extensive and time-consuming task of asking the user complex questions pertaining to their device for problem diagnosis. Existing methods of gathering and obtaining device information required for diagnostics are primarily manual and prone to human errors. This situation is only getting worse with the passage of time as devices become more powerful and capable of handling more sophisticated tasks with hundreds of configurable parameters.

Another method of support that is gaining strength is users helping each other, e.g. via forums, blogs etc. Typically on a forum users share their experience and try to solve each other's problems. This has led to some enterprising enthusiasts starting paid forums, where the user's problems are solved for a charge. One issue with the forums is that the user has to sift through a vast amount of information to get to the information that they may want. Another issue is that the authenticity of the information itself may be in question, as there is no way to prove that the people responding to a question on a forum are experts on that subject.

Thus we see that a user has many options, and they have to try each one of these options themselves in order to solve their problem. This can become a time consuming process as a user must go to each of these sources, explain the issue and then check periodically to see if there are any replies.

Therefore we note that prior art methods have inherent limitations and are in need of improvement.

### SUMMARY

Broadly speaking, the present invention provides a method and a system for self-care wherein a user search query or question about a device issue is routed to an appropriate source taking into account device specifics, user preferences, user profile and source appropriateness. The user is freed from having to find the right source(s) and from having to put the question and device information in the right format for that source, since the present system and method can do this automatically.

In one embodiment, a user launches an app on the device and initiates a search query e.g. asking a specific question about a specific problem on their device; the app also gathers the device information e.g. device make, model, OS and firmware version and may use a rules engine to search a knowledgebase. If no results are found in the knowledgebase, regarding the search query, then an information query package is created on the server. The information query package includes the initial search query or the question asked by the user, the device make, model, OS and firmware versions, user preferences, user profile etc. The server then matches the information query package to one or more sources and then routes the information query package to these sources. Once results are received from the sources the same are displayed to the user.

The appropriateness of the source may further be narrowed down by also taking into account the device type (e.g. make, model, version) preferred language of the user, their time zone, preferred channel of communication, urgency of the issue amongst other items and matching the information query package to the appropriate source that fits the criteria of expertize in the user's device, availability, language, time zone, communication channel etc.

If no results are found when running a search query on a knowledgebase, a user is preferably given the option to initiate the process of seeking further information from outside sources. Even where results are available from the knowledgebase, the user may opt to initiate the process seeking further information or assistance. Exemplary sources may include but are not limited to internal and external forums, blogs, vlogs, customer support departments, manufacturer's support services, paid and free forums, crowd-sourced sites, other paid services that offer assistance to user's queries for monetary compensation etc.

The source appropriateness may be measured by mapping the device information, urgency of the information query, user preferences, user language, user and source time zone and availability. The information query package may also be routed to an appropriate source based on a user's preferences, profile, past actions etc.

Devices that can benefit from the system may include but are not limited to a mobile device for example a Smartphone, a tablet, a computer, a server, network appliance, set-top box, SmartTV, embedded device, computer expansion module, personal computer, laptop, tablet computer, personal data assistant, game device, e-reader, any appliances having internet or wireless connectivity and onboard automotive devices such as navigational and entertainment systems. Such devices may also benefit from the fact that there are hundreds of parameters and by machine reading the data elements and automatically including a select set of relevant parameters in a search query increased accuracy is ensured.

According to a first aspect of the invention, a computer-implemented method is provided for providing customer care to a user of an electronic device. Text added by the user in a query about the electronic device is received. A device profile of the electronic device is also retrieved. This device profile has a plurality of parameters. (This may be retrieved “fresh” or from a cache.) An information query package is then created with the received parameters of the device profile and the added text from the user. The customer care case is automatically routed to an appropriate forum based on an analysis carried out by the computer of the information query package.

The text may have been added by the user in a self-care query, such as a search of a knowledgebase. The information query package may be created after an unsuccessful search of the knowledgebase.

The device profile may be retrieved following or in response to a user or device request, such as during a self-care session. In certain embodiments, this may also be prompted by a customer service representative.

The parameters in the device profile may include the make and model of the device. They may also include at least one error log of the device. The parameters may include at least one manufacturer, carrier or service provider relevant to the device. In this case, the appropriate forum may include a forum sponsored by or about the manufacturer, carrier or service provider. The appropriate forum may include a forum about devices like the user's device.

The appropriate forum may be selected from the group consisting of: internal forums, external forums, customer service department forums, manufacturer support forums, blogs, vlogs, paid and free services.

The analysis may further take into account user entitlement or warranty, and/or at least one customer preference. For example, customer preferences may include: communication channel, language, time zone, paid or free, urgency, timeframe. It may also be a customer preference to set an expiry date (or deadline) for the question.

The analysis preferably automatically matches the information query package to a forum having particular expertise in devices having at least some of the parameters received in the device profile, and any problems or issues that may be interpreted from the added text.

The added text may be interpreted using natural language processing.

The added text may be received from the electronic device. In certain embodiments, the added text may be received from an app in communication with the electronic device (e.g. where the electronic device lacks keyboard or convenient input means).

When/if an answer is received from the forum, this may be displayed (e.g. on the electronic device or on a second device in communication with the electronic device).

According to a second aspect of the invention, a computer-implemented method is provided for providing customer care to a user of an electronic device. A database is maintained of available forums related to problems or issues of electronic devices. A customer care case is pre-screened to match at least one of the forums in the database based on compatibility between the customer care case and the expertise and availability of the forum. An information query package is made available to the forum for resolution of the customer care case, which contains a device profile, and text added by the user in a query.

According to a third aspect of the invention, a computer-implemented method is provided for assembling an information query package for resolution of a customer care issue by a selected forum. Text is received that was added by a user of an electronic device in a query. This query includes text relevant to the customer care issue. A device profile of the electronic device is received. Parameters for the user and device are established related to country, service provider, language, subscription, time zone. User preference parameters and user entitlement parameters are received or inferred. The added text, device profile, established parameters, user preference parameters, and user entitlement parameters are assembled into a format acceptable to the selected forum to provide an information query package. The information query package is referred or made available to the selected forum for resolution of the customer care issue.

### BRIEF DESCRIPTION OF THE FIGURES

FIG. 1 is a flow diagram illustrating a basic search method according to an aspect of the invention.

FIG. 2 is a flow diagram of referral to a forum for additional information following a knowledgebase search.

FIG. 3 is a diagram illustrating component assembly of an exemplary information query package.

FIG. 4 is a network diagram illustrating aspects of the system.

FIG. 5 is a flow diagram illustrating routing to various forum types.

FIG. 6 is a flow diagram illustrating query handling.

### DETAILED DESCRIPTION

Before embodiments are explained in detail, it is to be understood that the invention is not limited in its application to the details of the examples set forth in the following descriptions or illustrated drawings. It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein. The invention is capable of other embodiments and of being practiced or carried out for a variety of applications and in various ways. Also, it is to be understood that the phraseology and terminology used herein is for the purpose of description and should not be regarded as limiting. Before embodiments of the software modules or flow charts are described in detail, it should be noted that the invention is not limited to any particular software language described or implied in the figures and that a variety of alternative software languages may be used for implementation.

It should also be understood that many components and items are illustrated and described as if they were hardware elements. However, in at least one embodiment, the components comprised in the method and tool are actually implemented in software.

The present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Before embodiments are explained in detail, it is to be understood that the invention is not limited in its application to the details of the examples set forth in the following descriptions or illustrated drawings. It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein. The invention is capable of other embodiments and of being practiced or carried out for a variety of applications and in various ways. Also, it is to be understood that the phraseology and terminology used herein is for the purpose of description and should not be regarded as limiting. Before embodiments of the software modules or flow charts are described in detail, it should be noted that the invention is not limited to any particular software language described or implied in the figures and that a variety of alternative software languages may be used for implementation.

It should also be understood that many components and items are illustrated and described as if they were hardware elements. However, in at least one embodiment, the components comprised in the method and tool are actually implemented in software.

The present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. Computer code may also be written in dynamic programming languages that describe a class of high-level programming languages that execute at runtime many common behaviours that other programming languages might perform during compilation. JavaScript, PHP, Perl, Python and Ruby are examples of dynamic languages.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), and at least one communication interface. A computing device may include a memory for storing a control program and data, and a processor (CPU) for executing the control program and for managing the data, which includes user data resident in the memory and includes buffered content. The computing device may be coupled to a video display such as a television, monitor, or other type of visual display while other devices may have it incorporated in them (iPad, iPhone etc.). An application or an app or other simulation may be stored on a storage media such as a DVD, a CD, flash memory, USB memory or other type of memory media or it may be downloaded from the internet. The storage media can be coupled with the computing device where it is read and program instructions stored on the storage media are executed and a user interface is presented to a user. For example and without limitation, the programmable computers may be a server, network appliance, set-top box, SmartTV, embedded device, computer expansion module, personal computer, laptop, tablet computer, personal data assistant, game device, e-reader, or mobile device for example a Smartphone. Other devices include appliances having internet or wireless connectivity and onboard automotive devices such as navigational and entertainment systems.

The program code may execute entirely on a mobile device or partly on the mobile device as a stand-alone software package; partly on the mobile device and partly on a remote computer or entirely on the remote computer or server. In the latter scenario, the remote computer may be connected to the mobile device through any type of network, including a local area network (LAN) or a wide area network (WAN), or the connection may be made to the internet through a mobile operator network (e.g. a cellular network). The code is specialized to execute functions described herein which enable a smoother and more efficient technological process.

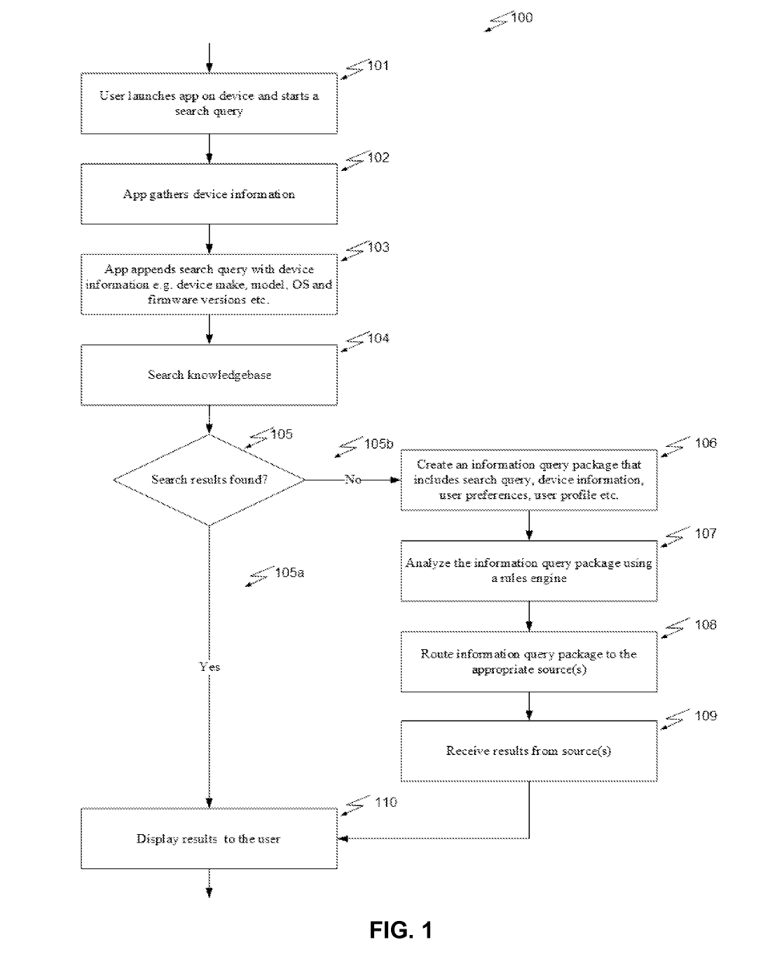

FIG. 1 shows one embodiment of the present method. A user launches an app on the user's device and starts a search query 101. As noted earlier, users are opting to solve their own problems rather than solely relying on service providers and their customer care departments. Apps and web based self-care systems are able to deliver a more convenient, always-on communication channels including forums. A search query may be a term that a user is searching for or may be a question that a user poses to others while seeking assistance regarding the issue on their device. In this application the terms “search query” and “question” are used interchangeably and carry the same connotation. For example a user enters a question “MMS not working on Samsung Galaxy S4” to start a search query.

Preferably the app may have an agent that has the capability to connect to the internet and also provides a user with an interface through which to enter a search query. A search query may be entered by inputting text in a graphical user interface or a user may be able to use a voice driven technology. There may be other methods for entering a search query.

The app gathers device information 102. One method of gathering device profiles is to have an app installed on the device that queries the device for its settings. One such app is described and taught in U.S. patent application Ser. No. 13/968,631, filed Aug. 16, 2013, which is incorporated herein by reference. Another related system using a device-based approach is described and taught in U.S. patent application Ser. No. 14/256,640, filed Apr. 18, 2014, which is incorporated herein by reference.

Information that can be gathered from the device may include but is not limited to: the device make, model and manufacture information, OS and firmware versions; applications (commonly referred to as “apps”) installed on the device; apps and processes running on the device; certificates on the device; user profile information; the character of any passcode used to authenticate a user (e.g. whether a password/passcode is used and the relative strength of that password, such as the number of characters); information regarding whether the device operating system has been tampered with by the user (e.g. an iOS device has been jailbroken, or a Google Android device has been rooted); and the data usage e.g. the amount of MB or GB used for a given billing period, the amount data used while roaming, or the relative amount compared to a data plan used by the user.

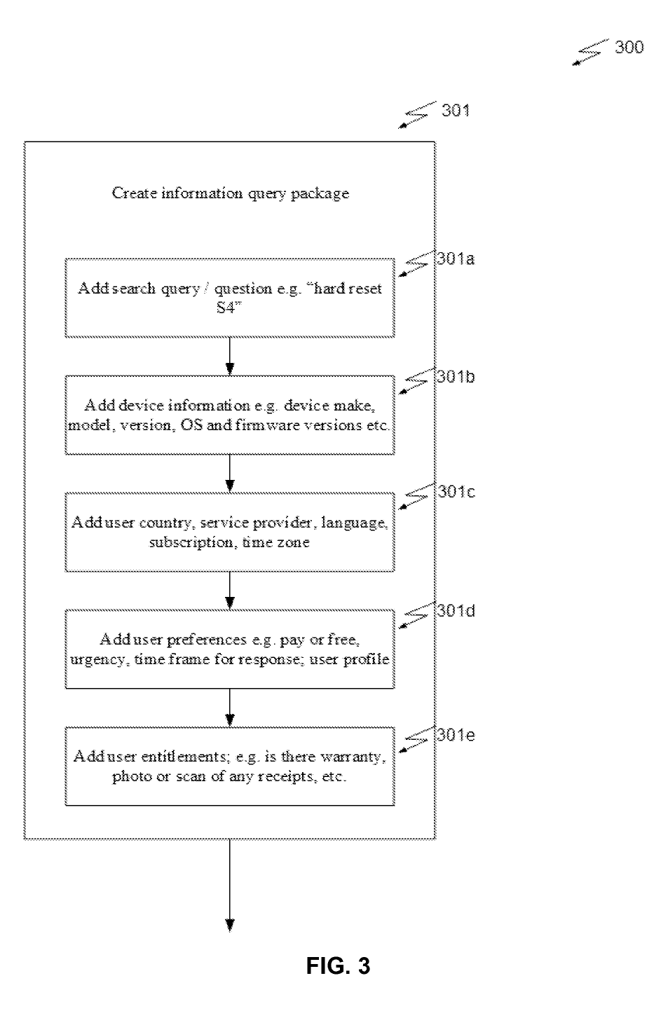

The app appends the user's search query with device information e.g. device make, model, OS and firmware versions etc. 103. More details on the additional information that may be taken into account are provided in FIG. 3.

The app can then search a knowledgebase 104. This knowledgebase may be an internal source of information that may be offered by a device manufacturer or a service provider to assist the users with their self-care efforts.

In one embodiment a rules engine may be used for searching the knowledgebase. In one embodiment there may be a separate set of rules for analyzing the search query and searching the knowledgebase.

A rules engine is a software system that executes one or more rules in a runtime environment. A rule engine may be viewed as a sophisticated if/then statement interpreter. The if/then statements that are interpreted are called rules. In one embodiment the app may have the agent and the rules engine embedded in it while also providing a user interface using which a user may be able to add text e.g. ask a question. In another embodiment the rules engine and the rules may be on a remote server.

A rule consists of some number of conditions and some number of actions. Generally the rules are written in a high-level business language that relates to the domain, storing the rules in the repository. The Rules Repository may also include proto-rules i.e. rules not completely validated yet for implementation. A database may be used as the preferred and exemplary embodiment to store the rules. In another embodiment the rules may be stored in a list, in a table or other method that may be suitable for so doing.

A rule can generally be represented as IF CONDITION(S) THEN RECOMMENDATION(S)/FIX(ES). It can consist of one or more conditions (the “IF”). One or more conditions can be grouped together by “and” and “or” and the order of operations can be further defined using brackets. In each condition, there could be a device attribute, a conditional operator (=, >, <, !=, exists, not exists) and then a text box in which to enter static text, numeric, date-time value or another device attribute. These conditions can then be rearranged, grouped, and joined together to form a bigger condition.

A rule should also contain a recommendation or a fix (the “THEN”). When saved, the rules will follow the Rules Lifecycle (status including but not limited to DRAFT, PENDING, VALIDATION, REJECTED, VALIDATED (Nth), ACTIVE, INACTIVE) and only active rules may be disseminated to other sources. The scope of a rule can be system-wide, device-specific, model-specific, manufacturer-specific, operator-specific etc.

The system checks if search results were found from the knowledgebase using the rules engine 105. If Yes 105a, results were found from the knowledgebase, then the system displays the results to the user 110.

If No 105b, no search results were found in the knowledgebase, then the system creates an information query package that includes the search query (or the question that the user may have asked), device information, user preferences, user profile etc. 106.

In one embodiment the system and method may also extract and add to the information query package data from the error logs (e.g. types of errors, number of errors in an error log, severity of errors, number and frequency of crashes of the device etc.).

There may be other sets of information that may be extracted from the device and added to the information query package.

The information query package is then analyzed using a rules engine 107. In one embodiment there may be a separate set of rules for analyzing the information query package and matching it to the appropriate source(s). In an alternate embodiment there may a combined set of rules that analyze the search query and search the knowledgebase as well as analyze the information query package to match it to the appropriate source(s).

For example, the app takes the question asked by the user e.g. “MMS not working on Samsung Galaxy S4” and gathers device make, device model, OS version, language, operator, location etc.:

Device Make=Samsung

Device Model=Galaxy S4

Operating System=Android 4.2.2

Language=English

Operator=Sprint

Location=New York, N.Y. USA

The information query package is matched and routed to the appropriate source(s) 108. In one embodiment the sources may include, but are not limited to internal and external forums, customer support departments, manufacturer's support services, paid and free forums, other paid services that offer assistance to user's queries for monetary compensation, blogs, vlogs etc.

There are several types of forums, for example question and answer type forum, where users can ask questions and get answers from the community, forums that have “Tips and Tricks” and discussions on work-arounds.

Another type of forum is where users can share an idea and start a discussion around it, and then share progress on the idea. Another type of forum is where users can share a problem or bug and discuss it with the community e.g. issues and bug-report forums.

Yet another type of forum is one where users can share general announcements and start a discussion on this topic; for example major product announcements, fixes and release notes.

Results are received from the source(s) 109. For example the app may receive search results from a customer support department and a crowd-sourced site.

The results are displayed to the user 110. For example, these may be displayed using the display of the device, such as on a touchscreen of a Smartphone, or the display of a SmartTV etc. For devices that may not have their own native display e.g. a set top box, the search results may be displayed on a display connected to the device; in this case a TV or a monitor.

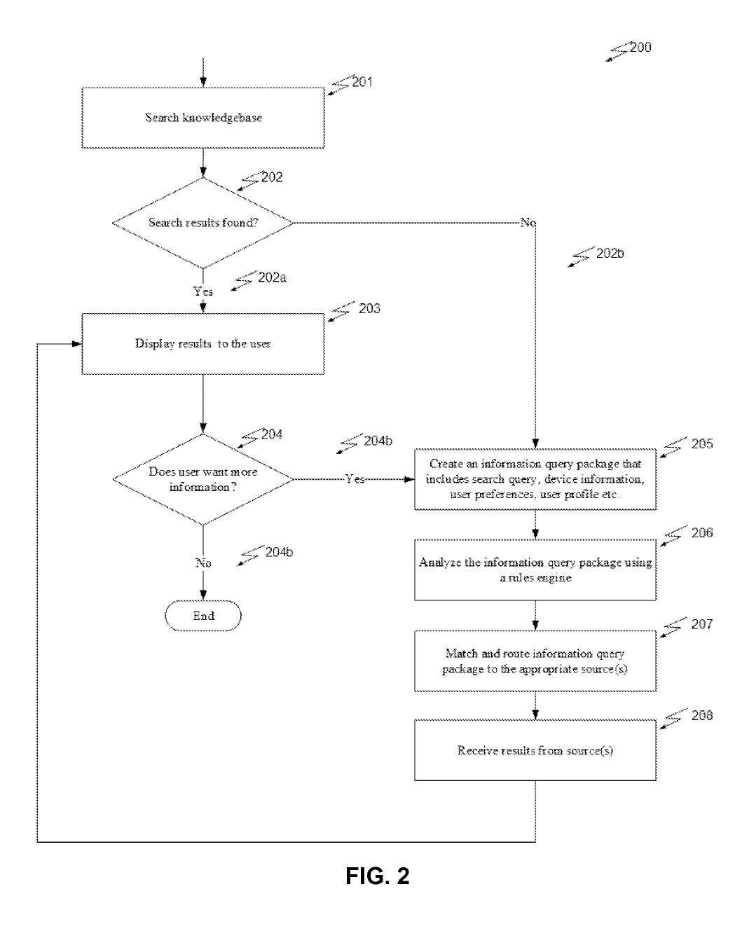

FIG. 2 shows a user initiated scenario 200. After a search of the knowledgebase 201, the system checks whether search results were found 202.

If Yes 202a, search results were found in the internal knowledgebase, the results may be displayed to the user 203. For example, these may be displayed using the display of the device, such as on a touchscreen of a Smartphone, or the display of a SmartTV etc. For devices that may not have their own native display e.g. a set top box, the search results may be displayed on a display connected to the device; in this case a TV or a monitor.

If No 202b, no results were found in the internal knowledgebase, then the method proceeds to step 205.

The system checks whether the user wants more information 204. In one embodiment a graphic user interface may be used for preferably asking a user if they are satisfied with the provided information or that they would like more information from other sources to get more help with the issue. If No 204a, the user does not want more information, then the process ends.

If Yes 204b, the user wants more information, then an information query package is created.

The information query package is analyzed using a rules engine 206. The rules engine may be local to the device or may be remote and running on a server that is connected to a network and accessible by the device of the user. Some exemplary rules engines are described in U.S. Ser. Nos. 13/968,631 and 14/256,640, both incorporated herein by reference.

The information query package is matched and routed to the appropriate source(s) 207. After receiving results from the appropriate sources 208, the results may be displayed to the user 203.

FIG. 3 shows the process of information query package creation 300 before it is sent to an appropriate source(s). In one embodiment an information query package is created 301. The search query/question that the user may have asked is added to the information query package 301a. For example a user may have asked a question: “Bluetooth on device is not working”.

Device information is also added to the information query package e.g. device make, model, OS and firmware versions 301b. Information that can be gathered from the device and may be included in the information query package may include but is not limited to: the device make, model, OS and firmware versions; applications (commonly referred to as “apps”) installed on the device; apps and processes running on the device; certificates on the device; user profile information; the character of any passcode used to authenticate a user (e.g. whether a password/passcode is used and the relative strength of that password, such as the number of characters); information regarding whether the device operating system has been tampered with by the user (e.g. an iOS device has been jailbroken, or a Google Android device has been rooted); and the data usage e.g. the amount of MB or GB used for a given billing period etc.

Other information such as user country, service provider, language (or language of preference), subscription, time zone, etc. may also be added 301c.

User preferences e.g. whether a user prefers a paid service or a free service, urgency of the matter, time frame for the response, past user actions may also be added 301d.

User entitlements, e.g. is there warranty on the device or gadget where the user is having a problem, any scan or photo of the sales receipt that the user may have added as a proof of purchase and to establish a date to claim warranty may also be added 301e.

Creating the information query package may include but is not limited to capturing the important information gathered from the device i.e. machine read data, delta of parameters, user preferences including whether the user wants to engage a paid service or a free service, user profile, along with the initial question or search query inputted by the user.

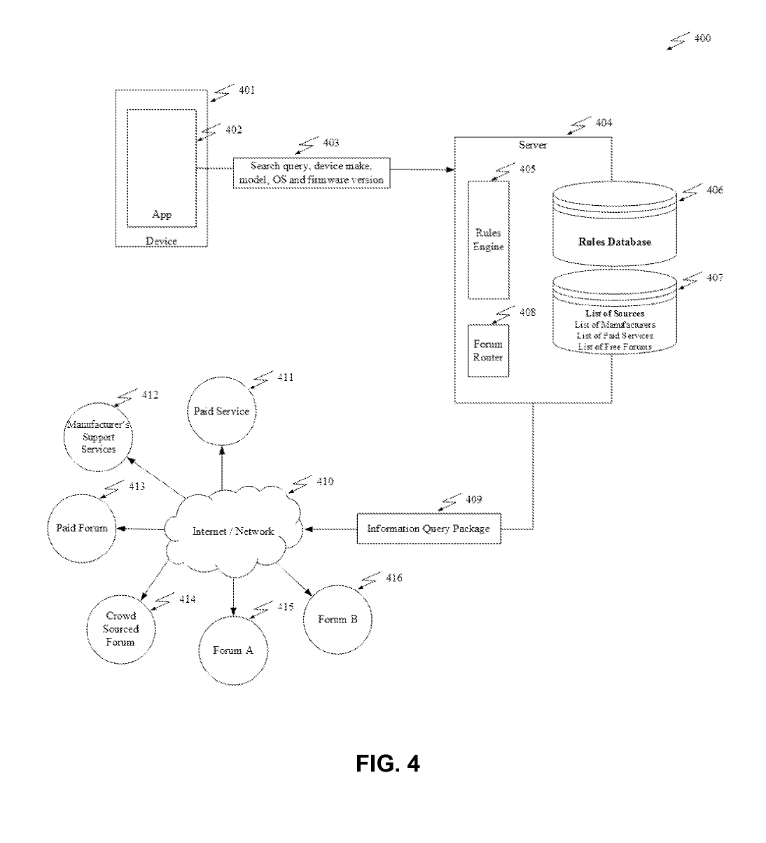

FIG. 4 shows a network view 400. Device 401 has app 402 installed on it.

Devices that can benefit from the system may include but are not limited to a mobile device for example a Smartphone, a tablet, a computer, a server, network appliance, set-top box, SmartTV, embedded device, computer expansion module, personal computer, laptop, tablet computer, personal data assistant, game device, e-reader, any appliances having internet or wireless connectivity and onboard automotive devices such as navigational and entertainment systems. Such devices may also benefit from the fact that there are hundreds of parameters and by machine reading the data elements and automatically including a select set of relevant parameters in a search query ensures increased accuracy.

It should be understood that although the term application (or app) has been used as an example in this disclosure but in essence the term may also imply to any other piece of software code where the embodiments are incorporated. The software app or application can be implemented in a standalone configuration or in combination with other software programs and is not limited to any particular operating system or programming paradigm described here.

The app gathers and sends the user search query, device information e.g. device make and model, OS and firmware versions, and any other relevant information 403 to the server 404. The server 404 is a computing device e.g. a computer that is accessible to devices over a network.

The server 404 houses rules engine 405 and a rules database 406. One embodiment may use a separate set of rules that are specific to matching an information query package to an appropriate source. For example the rules take into account the information that has been machine read from the device along with the information that the user may have provided for example a specific question, or a search query entered by the user, user preferences in terms of language, time zone, medium of communications etc. The rules engine finds the best fit in terms of a source that may be available in the same time zone as the user, speaks the language that the user prefers, has expertise in tackling and solving the specific problem that the user is facing, with the specific device make and model that the user has etc.

The server 404 also stores a list of sources 407. The list of source may a detailed list of all the sources that may be relevant to the devices, their manufacturers, their support groups, the free and paid forums, and other such entities. For example there may be a database that lists all the sources, their availability, and their skills in terms of solving specific problems with specific devices, their language skills, preferred medium of communications, case load i.e. how busy they are etc. The list of sources may be stored in a database or the list of sources may be stored in a file that is accessible to other components on the server for example the forum router 408.

The server 404 also contains the forum router 408. The forum router may have the logic of matching an information query package to one or more appropriate sources and routing the information query package to the matched source(s). In one embodiment the forum may also preferably have the logic of putting the information query package into a format that is acceptable to the matched source. The forum router may also take into account the source API and format the information query package using the appropriate API structure specific to the matched source.

The server creates the information query package 409 and sends it to the appropriate source(s) via the network e.g. internet 410.

Examples of appropriate sources may include paid services 411, manufacturer's support services 412, paid forums 413, crowd sourced forums 414, exemplary ForumA 415, and exemplary ForumB 416.

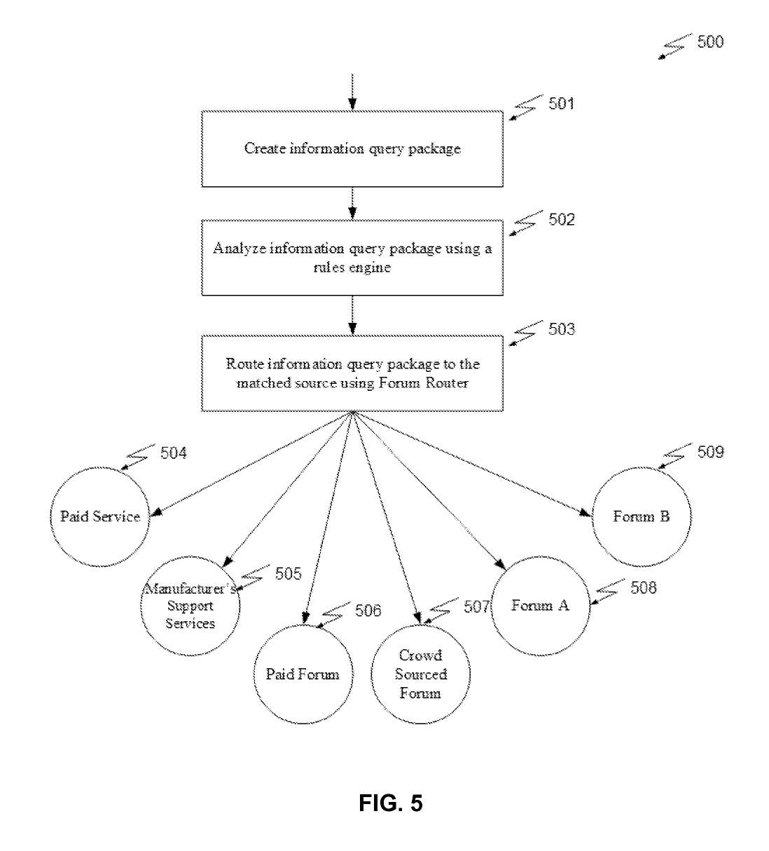

FIG. 5 shows the process of routing to various forum types 500. An information query package is created 501. The information query package may contain all the information that has been gathered at the device regarding the device itself as well as the additional information that may be relevant to the user, user preferences and user profile, etc. Some or all of the additional information about user preferences and a user profile may be stored at the server and taken into account along with the information that has been gathered from the device.

The information query package is analyzed using a rules engine 502. Depending on the user device OS, firmware and versions etc. the information query package is matched to the appropriate source and routed to the relevant source in the correct format. In one embodiment when matching the information query package to a source the system preferably takes into account the search query entered by a user, all of the information that may have been gathered from the device e.g. the device make, model, OS and firmware versions, preferred language of the user, user country, service provider, time zone, user preferences, user profiles and match it to a source or multiple sources that fits all of this criteria.

The information query package is then routed to the matched source(s) using forum router 503. The forum router may have the logic of matching an information query package to the appropriate source and putting the information query package in the requisite format. For example each source may have an API and the requirements of how they receive an information query package from an external source may vary.

Exemplary sources may include but are not limited to paid services 504, manufacturer's support services 505, paid forums 506, crowd sourced forums 507, exemplary ForumA 508, and exemplary ForumB 509.

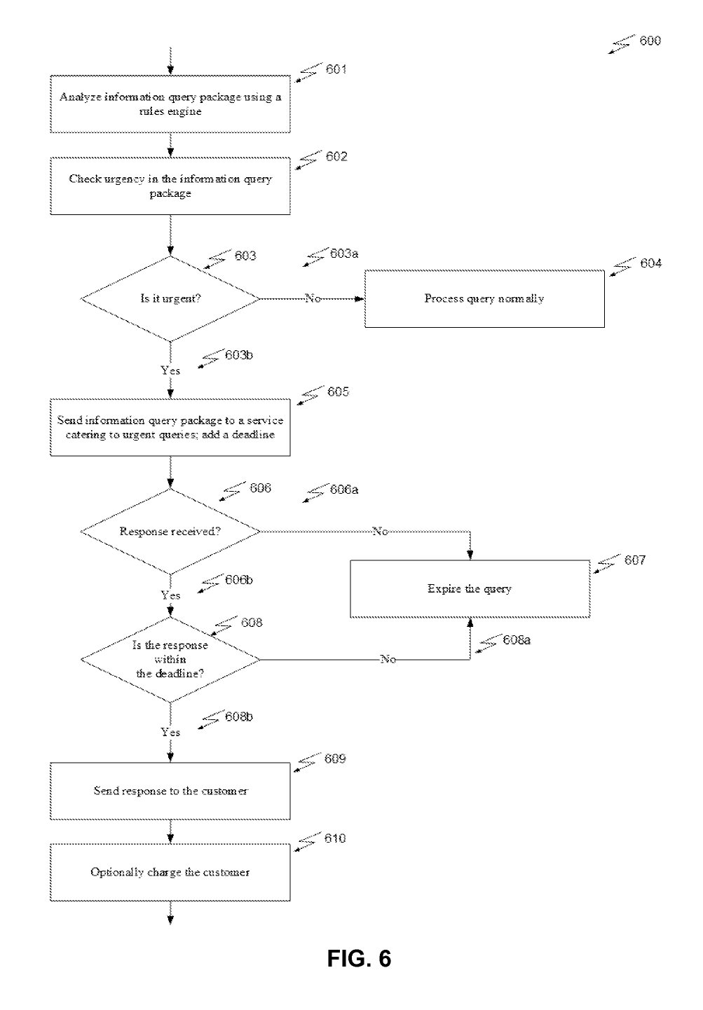

FIG. 6 shows the process of routing an urgent information query package to the appropriate source(s) 600. The information query package is analyzed using a rules engine and specific rules to match an information query package to the appropriate source(s) 601.

The urgency in the information query package is checked 602. The user can specify if the information query package is urgent (or this may be inferred from other information or context—e.g. a close deadline being provided) 603.

If No 603a, the information query package does not state that the user needs the results urgently then the query is processed normally 604.

If Yes 603b, the information query package states that the user requires the results urgently, then the information query package may be routed to a source that specializes in responding to urgent search queries, which may be available immediately. Using an urgent service may result in the user having to pay for the response.

The information query package is sent to a service catering to urgent queries and a deadline is added 605. The deadline may be added to the information query package so that once the source or multiple sources receive the information query package, they are clear in terms of the deadline and may be required to respond within this timeframe.

For example if the user is in Pacific Time Zone and the current time is within the business hours, the information query package may be routed to a source that is in the same time zone. In another example if the user is in Eastern Time Zone and the current time is outside of the business hours, the information query package may be routed to a source in another time zone (e.g. Pacific Time Zone) where it is still normal business hours.

The system checks if a response has been received from a source to which the information query package was sent 606. If No 606a, no response has been received and the deadline has passed, the query may be expired 607 and optionally the user may be informed that no response was received for the question that the user had asked from any of the sources.

If Yes 606b, a response has been received from a source to which the information query package was sent, the system checks if the response is within the deadline 608. If No 608a, the response is not within the deadline and the deadline has passed, the query may be expired 607 and optionally the user may be informed that no response was received for the question that the user had asked from any of the sources.

If Yes 608b, a response has been received from one or more of the sources to which an information query package was routed, and the response is within the deadline, then the response is sent to the user 609. In one embodiment the results may be displayed to the user; for example using the display of the device; display some or all of the results that have been received from the different source(s). In one embodiment preferably display the search results on a touchscreen of a Smartphone, or the display of a SmartTV etc. For devices that may not have their own native display e.g. a set top box, the search results may be displayed on a display that may be connected to the said device; in this case a TV or a monitor.

In certain cases, the system may arrange a charge to the user 610. The user may be charged by credit card, or on an account so that they are billed at the end of the billing cycle, or the user is charged as part of their subscription etc.

It is to be understood that the rules engine is not necessarily linear when executing the rules. There may be a common starting point when executing the rules, but as the rules get executed and as information gathered from the device and additional information is analyzed, one rule may trigger another rule that may be part of another set of rules. There may also be loops, so that there are rules embedded within rules, or a rule many call another rule as part of its execution. The rule that is called from within the loop or the rule that is called as part of the execution of another rule may not be fixed or static but may depend on the situation and vary as needed.

The program code may execute entirely on a mobile device or partly on the mobile device as a stand-alone software package; partly on the mobile device and partly on a remote computer or entirely on the remote computer or server. In the latter scenario, the remote computer may be connected to the mobile device through any type of network, including a local area network (LAN) or a wide area network (WAN), or the connection may be made to the internet through a mobile operator network (e.g. a cellular network).

Several exemplary embodiments/implementations have been included in this disclosure, but the intent is to cover all such areas that may be benefit from the present system and method.

The above examples are not intended to be limiting, but are illustrative and exemplary.

The examples noted here are for illustrative purposes only and may be extended to other implementation embodiments. While several embodiments are described, there is no intent to limit the disclosure to the embodiment(s) disclosed herein. On the contrary, the intent is to cover all practical alternatives, modifications, and equivalents.

What is claimed is:

1. A computer-implemented method of providing customer care to a user of an electronic device, comprising:
receiving text added by the user in a query about the electronic device;
receiving a device profile of the electronic device, the device profile having a plurality of parameters;
creating an information query package with the received parameters of the device profile and the added text from the user; and
automatically routing the customer care case to an appropriate forum based on an analysis carried out by the computer of the information query package.

2. The method of claim 1, wherein the text was added by the user in a self-care query.

3. The method of claim 1, wherein the text was added by the user in a search of a knowledgebase.

4. The method of claim 3, wherein the information query package is created after an unsuccessful search of the knowledgebase.

5. The method of claim 1, wherein the receiving step occurs in response to a user or device request.

6. The method of claim 1, wherein the receiving step occurs during a self-care session.

7. The method of claim 1, wherein the receiving step is prompted by a customer service representative.

8. The method of claim 1, wherein the parameters include the make and model of the device.

9. The method of claim 1, wherein the parameters include at least one error log of the device.

10. The method of claim 1, wherein the parameters include at least one manufacturer, carrier or service provider relevant to the device.

11. The method of claim 10, wherein the appropriate forum may include a forum sponsored by or about the manufacturer, carrier or service provider.

12. The method of claim 10, wherein the appropriate forum may include a forum about devices like the user's device.

13. The method of claim 1, wherein the appropriate forum is selected from the group consisting of: internal forums, external forums, customer service department forums, manufacturer support forums, blogs, vlogs, paid and free services.

14. The method of claim 1, wherein the analysis further takes into account user entitlement or warranty.

15. The method of claim 1, wherein the analysis further takes into account at least one customer preference.

16. The method of claim 15, wherein the at least one customer preference is selected from the group consisting of: communication channel, language, time zone, paid or free, urgency, timeframe.

17. The method of claim 15, wherein the at least one customer preference includes setting an expiry date for the question.

18. The method of claim 1, wherein the analysis automatically matches the information query package to a forum having particular expertise in devices having at least some of the parameters received in the device profile, and any problems or issues that may be interpreted from the added text.

19. The method of claim 18, wherein the added text is interpreted using natural language processing.

20. The method of claim 1, wherein the added text is received from the electronic device.

21. The method of claim 1, wherein the added text is received from an app in communication with the electronic device.

22. The method of claim 1, further comprising:
receiving and displaying an answer to the query from the forum.

23. The method of claim 22, wherein the answer is displayed on the electronic device.

24. The method of claim 22, wherein the answer is displayed on a second device in communication with the electronic device.

25. A computer-implemented method of providing customer care to a user of an electronic device, comprising:
maintaining a database of available forums related to problems or issues of electronic devices;
pre-screening a customer care case to match at least one of the forums in the database based on compatibility between the customer care case and the expertise and availability of the forum; and
making an information query package available to the forum for resolution of the customer care case, the information query package containing a device profile, and text added by the user in a query.

26. A computer-implemented method of assembling an information query package for resolution of a customer care issue by a selected forum, comprising:
receiving text added by a user of an electronic device in a query, the query including text relevant to the customer care issue;
receiving a device profile of the electronic device;
establishing parameters for the user and device related to country, service provider, language, subscription, time zone;
receiving or inferring user preference parameters;
receiving or inferring user entitlement parameters;
assembling the added text, device profile, established parameters, user preference parameters, and user entitlement parameters into a format acceptable to the selected forum to provide an information query package; and
referring or making available the information query package to the selected forum for resolution of the customer care issue.
